(19) United States
(12) Patent Application Publication
(10) Pub. No.: US 2026/0067629 A1
(43) Pub. Date: Mar. 5, 2026

(54) SPATIAL ACOUSTIC PROCESSING DEVICE AND SPATIAL ACOUSTIC PROCESSING METHOD

(71) Applicant: JVCKENWOOD Corporation, Yokohama-shI (JP)

(72) Inventor: Takahiro GEJO, Yokohama-shi (JP)

(21) Appl. No.: 19/382,626

(22) Filed: Nov. 7, 2025

Related U.S. Application Data
(63) Continuation of application No. PCT/JP2024/014644, filed on Apr. 11, 2024.

(30) Foreign Application Priority Data
May 30, 2023 (JP) 2023-088540

(51) Int. Cl. H04S 7/00

(52) U.S. Cl. CPC H04S 7/301; H04S 2420/01

(57) ABSTRACT

A spatial acoustic processing device includes: a filter storage unit configured to store a filter set having a plurality of first filters which are based on one spatial acoustic transfer characteristic; convolution units configured to generate a plurality of first convolution signals by convolving a plurality of first filters in parallel into a first input signal of a first channel; a fluctuation signal generation unit configured to generate a first fluctuation signal by performing non-linear processing on a plurality of convolution signals; and a filter processing unit configured to generate an output signal by convolving a second filter into the first fluctuation signal.

### CROSS REFERENCE TO RELATED APPLICATION

This application is a US Bypass Continuation of International Patent Application PCT/JP2024/014644 filed on Apr. 11, 2024, which is based upon and claims the benefit of priority from Japanese patent application No. 2023-88540, filed on May 30, 2023, the disclosure of which is incorporated herein in its entirety by reference.

The present disclosure relates to a spatial acoustic processing device and a spatial acoustic processing method.

### BACKGROUND

Patent Literature 1 discloses an audio signal processing apparatus that reproduces audio signals in a multichannel surround sound system with 2-ch audio signals. This audio signal processing apparatus convolves a selected head-related transfer function with the audio signal of each channel. The audio signal processing apparatus calculates, for the audio signal of each channel, a center position of fluctuation and sets a width of fluctuation.

[Patent Literature 1] International Patent Publication No. WO 2013/183392

### SUMMARY

Incidentally, sound localization techniques include an out-of-head localization technique, which localizes sound images outside the head of a listener by using headphones. The out-of-head localization technique localizes sound images outside the head by canceling characteristics from the headphones to the ears and giving four characteristics from stereo speakers to the ears.

In out-of-head localization reproduction, measurement signals (impulse sounds etc.) that are output from 2-channel (which is referred to hereinafter as “ch”) speakers are recorded by microphones placed on the listener (user)'s ears. Then, a processor generates a filter based on a sound pickup signal obtained by impulse response. Accordingly, a filter in accordance with spatial acoustic transfer characteristics from the speakers to the ear canal where the microphones are placed is generated. The generated filter is convolved to 2-ch audio signals, thereby implementing out-of-head localization reproduction.

Further, in order to generate a filter for canceling out characteristics from headphones to ears, characteristics from the headphones to a part near the ear or to an eardrum (ear canal transfer function ECTF; also referred to as ear canal transfer characteristics) are measured by microphones worn on listener's ears.

When sound emitted from a sound source in a real space actually reaches the listener's ears, various elements may exhibit non-linearity. It is difficult to completely reproduce the actual environment in a spatial acoustic processing system such as an out-of-head localization device.

One of non-linear factors that can be considered is spatial fluctuations (strictly speaking, there are fluctuations in everything including a sound source itself and human bodies). It has been difficult to simulate these fluctuations in related art since the fluctuations are processed by using only a unique filter coefficient at an instantaneous moment. This interferes with a high sense of realism and accurate illusory effects.

The present disclosure has been made in view of the aforementioned circumstances and an object of the present disclosure is to provide a spatial acoustic processing device and a spatial acoustic processing method capable of reproducing sounds with a high sense of realism.

A spatial acoustic processing device according to this embodiment includes: a filter storage unit configured to store a filter set having a plurality of first filters which are based on one spatial acoustic transfer characteristic; a first convolution unit configured to generate a plurality of first convolution signals by convolving the plurality of first filters in parallel into a first input signal of a first channel; a first fluctuation signal generation unit configured to generate a first fluctuation signal by performing non-linear processing on the plurality of first convolution signals; and a filter processing unit configured to generate an output signal by convolving a second filter into the first fluctuation signal.

A spatial acoustic processing method according to this embodiment includes: a step of reading out a filter set having a plurality of first filters which are based on one spatial acoustic transfer characteristic from a filter storage unit; a first convolution step configured to generate a plurality of first convolution signals by convolving the plurality of first filters in parallel into a first input signal of a first channel; a first fluctuation signal step of generating a first fluctuation signal by performing non-linear processing on the plurality of first convolution signals; and a filter processing step of generating an output signal by convolving a second filter into the first fluctuation signal.

According to the present disclosure, it is possible to provide a spatial acoustic processing device and a spatial acoustic processing method capable of reproducing sounds with a high sense of realism.

### BRIEF DESCRIPTION OF THE DRAWINGS

FIG. 1 is a block diagram showing an out-of-head localization device according to an embodiment;

FIG. 2 is a schematic diagram showing a configuration of a measurement device that measures spatial acoustic transfer characteristics;

FIG. 3 is a block diagram showing a configuration of a signal processing apparatus used for a measurement processor;

FIG. 4 is a block diagram showing a configuration of a main part of a spatial acoustic processing unit;

FIG. 5 is a block diagram showing a configuration of an inverse filter unit; and

FIG. 6 is a flowchart showing a spatial acoustic processing method according to this embodiment.

### DETAILED DESCRIPTION

The overview of sound localization processing according to this embodiment is described hereinafter. In this embodiment, an example in which out-of-head localization processing is performed, as spatial acoustic processing, by using spatial acoustic transfer characteristics and ear canal transfer characteristics will be described.

The spatial acoustic transfer characteristics are transfer characteristics from a sound source such as a speaker to the ear canal. The ear canal transfer characteristics are transfer characteristics from a speaker unit of headphones or earphones to the eardrum. In this embodiment, the spatial acoustic transfer characteristics are measured with no headphones or no earphones worn, the ear canal transfer characteristics are measured with headphones or earphones worn, and out-of-head localization processing is implemented with these measurement data. One of the features of this embodiment is a microphone system for measuring spatial acoustic transfer characteristics or ear canal transfer characteristics.

The out-of-head localization processing according to this embodiment is executed on a user terminal such as a personal computer, a smart phone, or a tablet PC. The user terminal is an information processing device including processing means such as a processor, storage means such as a memory or a hard disk, display means such as a liquid crystal monitor, and input means such as a touch panel, a button, a keyboard and a mouse. The user terminal may have a communication function for transmitting and receiving data. Further, the user terminal is connected to output means (an output unit) with headphones or earphones. The connection between the user terminal and the output means may be a wired connection or a wireless connection.

### (Out-of-Head Localization Device)

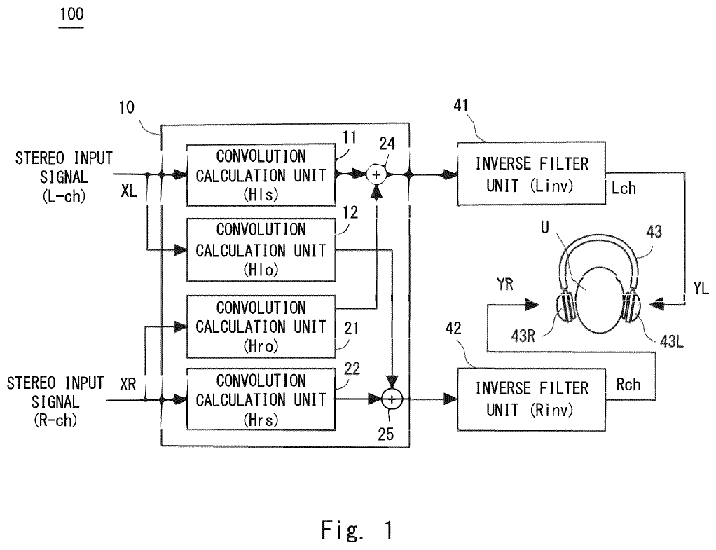

FIG. 1 shows a block diagram of an out-of-head localization device 100, which is an example of a sound field reproducing device according to this embodiment. The out-of-head localization device 100 reproduces a sound field for a user U who wears headphones 43. Thus, the out-of-head localization device 100 performs sound localization processing for L-ch and R-ch stereo input signals XL and XR. The L-ch and R-ch stereo input signals XL and XR are analog audio reproduced signals that are output from a CD (Compact Disc) player or the like or digital audio data such as mp3 (MPEG Audio Layer-3). Note that the audio reproduced signals or digital audio data are collectively referred to as a reproduced signal. In other words, the L-ch and R-ch stereo input signals XL and XR are reproduced signals.

In this embodiment, the out-of-head localization device 100 performs arithmetic processing for appropriately performing sound localization processing using filters. An arithmetic processing unit of the out-of-head localization device 100 is a personal computer (PC), a tablet terminal, a smart phone, or the like, and includes a memory and a processor. The memory stores processing programs, various parameters, measurement data, and the like. The processor executes a processing program stored in the memory. The processor executes the processing program and thereby each process is executed. The processor may be, for example, a CPU (Central Processing Unit), an FPGA (Field-Programmable Gate Array), a DSP (Digital Signal Processor), an ASIC (Application Specific Integrated Circuit), a GPU (Graphics Processing Unit), or the like.

Note that the out-of-head localization device 100 is not limited to a physically single device, and a part of processing may be performed in a different device. For example, a part of processing may be performed by a smart phone or the like, and the remaining processing may be performed by a DSP (Digital Signal Processor) or the like built in the headphones 43.

The out-of-head localization device 100 includes a spatial acoustic processing unit 10, an inverse filter unit 41 for storing an inverse filter Linv, an inverse filter unit 42 for storing an inverse filter Rinv, and headphones 43. The spatial acoustic processing unit 10, the inverse filter unit 41, and the inverse filter unit 42 can be specifically implemented by a processor or the like.

The spatial acoustic processing unit 10 includes convolution calculation units 11 to 12 and 21 to 22 for storing spatial acoustic transfer characteristics Hls, Hlo, Hro, and Hrs, and adders 24, 25. The convolution calculation units 11 to 12 and 21 to 22 perform convolution processing using the spatial acoustic transfer characteristics. The stereo input signals XL and XR from an audio player or the like are input to the spatial acoustic processing unit 10. The spatial acoustic transfer characteristics are set to the spatial acoustic processing unit 10. The spatial acoustic processing unit 10 convolves a filter of the spatial acoustic transfer characteristics (which is hereinafter referred to also as a spatial acoustic filter) into each of the stereo input signals XL and XR of each ch. The spatial acoustic transfer characteristics may be a head-related transfer function HRTF measured in the head or auricle of a person being measured, or may be the head-related transfer function of a dummy head or a third person.

The spatial acoustic transfer function is a set of four spatial acoustic transfer characteristics Hls, Hlo, Hro and Hrs. Data used for convolution in the convolution calculation units 11 to 12 and 21 to 22 is a spatial acoustic filter. The spatial acoustic filter is generated by cutting out the spatial acoustic transfer characteristics Hls, Hlo, Hro and Hrs with a predetermined filter length.

Each of the spatial acoustic transfer characteristics Hls, Hlo, Hro and Hrs is acquired in advance by impulse response measurement or the like. For example, the user U wears respective microphones on the left and right ears. Left and right speakers placed in front of the user U output impulse sounds for performing impulse response measurements. Then, the measurement signals such as the impulse sounds output from the speakers are picked up by the microphones. The spatial acoustic transfer characteristics Hls, Hlo, Hro and Hrs are acquired based on sound pickup signals in the microphones. The spatial acoustic transfer characteristics Hls between the left speaker and the left microphone, the spatial acoustic transfer characteristics Hlo between the left speaker and the right microphone, the spatial acoustic transfer characteristics Hro between the right speaker and the left microphone, and the spatial acoustic transfer characteristics Hrs between the right speaker and the right microphone are measured.

The convolution calculation unit 11 convolves the spatial acoustic filter in accordance with the spatial acoustic transfer characteristics Hls into the L-ch stereo input signal XL. The convolution calculation unit 11 outputs convolution calculation data to the adder 24. The convolution calculation unit 21 convolves the spatial acoustic filter in accordance with the spatial acoustic transfer characteristics Hro into the R-ch stereo input signal XR. The convolution calculation unit 21 outputs convolution calculation data to the adder 24. The adder 24 adds the two pieces of convolution calculation data and outputs the resultant data to the inverse filter unit 41.

The convolution calculation unit 12 convolves the spatial acoustic filter in accordance with the spatial acoustic transfer characteristics Hlo into the L-ch stereo input signal XL. The convolution calculation unit 12 outputs the convolution calculation data to the adder 25. The convolution calculation unit 22 convolves the spatial acoustic filter in accordance with the spatial acoustic transfer characteristics Hrs into the R-ch stereo input signal XR. The convolution calculation unit 22 outputs convolution calculation data to the adder 25. The adder 25 adds the two pieces of convolution calculation data and outputs the resultant data to the inverse filter unit 42. Details of the processing of the convolution calculation units 11 and 12 will be described later.

Inverse filters Linv and Rinv that cancel headphone characteristics (characteristics between the reproduction unit of the headphones and the microphone) are set in the inverse filter units 41 and 42. Then, the inverse filters Linv and Rinv are convolved into the reproduced signals (convolution calculation signals) on which the processing in the spatial acoustic processing unit 10 has been performed. The inverse filter unit 41 convolves the inverse filter Linv of the L-ch headphone characteristics into the L-ch signal from the adder 24. Likewise, the inverse filter unit 42 convolves the inverse filter Rinv of the R-ch headphone characteristics into the R-ch signal from the adder 25. The inverse filters Linv and Rinv cancel out the characteristics from the headphone unit to the microphone when the headphones 43 are worn. The microphone may be placed at any position between the entrance of the ear canal and the eardrum.

The inverse filter unit 41 outputs the processed L-ch signal YL to the left unit 43L of the headphones 43. The inverse filter unit 42 outputs the processed R-ch signal YR to the right unit 43R of the headphones 43. The user U wears the headphones 43. The headphones 43 output the L-ch signal YL and the R-ch signal YR (hereinafter, the L-ch signal YL and the R-ch signal YR are collectively referred to as a stereo signal or an output signal) toward the user U. This can reproduce sound images localized outside the head of the user U.

As described above, the out-of-head localization device 100 performs out-of-head localization processing using the spatial acoustic filters in accordance with the spatial acoustic transfer characteristics Hls, Hlo, Hro, and Hrs, and the inverse filters Linv and Rinv of the headphone characteristics. In the following description, the spatial acoustic filters in accordance with the spatial acoustic transfer characteristics Hls, Hlo, Hro, and Hrs, and the inverse filters Linv and Rinv of the headphone characteristics are collectively referred to as an out-of-head localization processing filter. In the case of 2-ch stereo reproduced signals, the out-of-head localization filter is composed of four spatial acoustic filters and two inverse filters. The out-of-head localization device 100 then carries out convolution calculation processing on the stereo reproduced signals by using the out-of-head localization filter composed of totally six filters and thereby performs out-of-head localization processing. The out-of-head localization filter is preferably based on the measurement of the individual user U. For example, the out-of-head localization filter is set based on sound pickup signals picked up by the microphones worn on the ears of the user U.

As described above, the spatial acoustic filters and the inverse filters Linv and Rinv for headphone characteristics are filters for audio signals. These filters are convolved into the reproduced signals (stereo input signals XL and XR), whereby the out-of-head localization device 100 executes the out-of-head localization processing. In this embodiment, processing for generating the spatial acoustic filter is one of technical features. Specifically, a plurality of filters are set in each of the convolution calculation units 11, 12, 21, and 22.

For example, each of the convolution calculation units 11, 12, 21, and 22 concurrently convolves the plurality of filters into the input signal, thereby generating a plurality of convolution signals. Further, the spatial acoustic processing unit 10 performs non-linear processing on the plurality of convolution signals, thereby generating a fluctuation signal. By convolving the inverse filter into the fluctuation signal, an output signal is generated.

### (Measurement Device of Spatial Acoustic Transfer Characteristics)

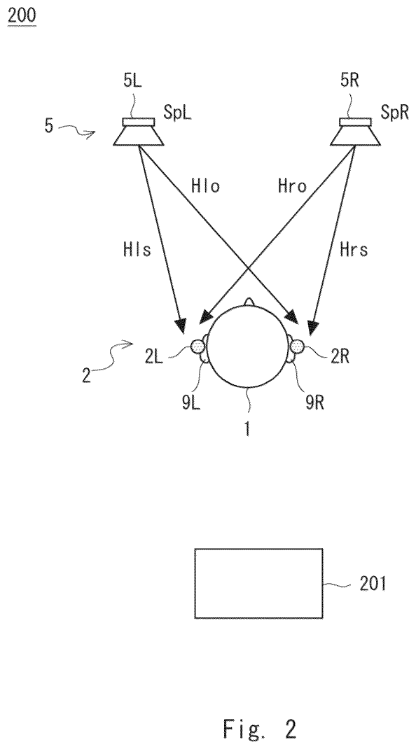

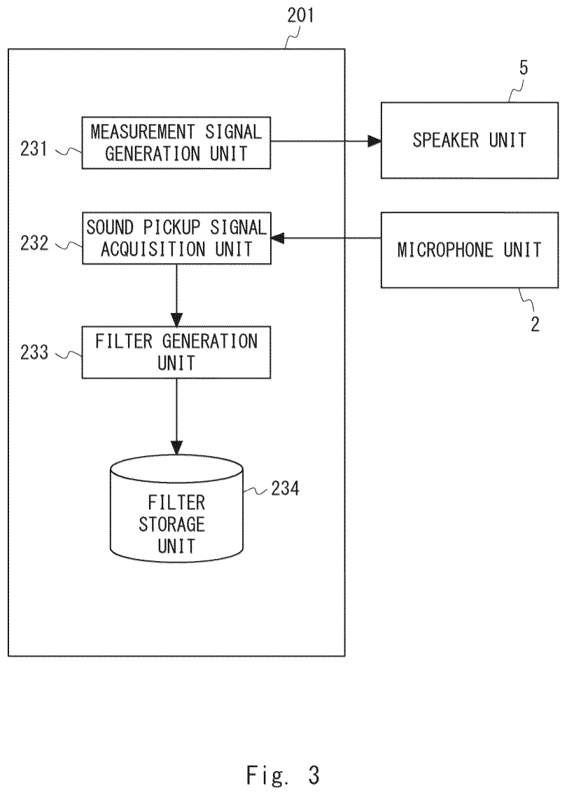

With reference to FIGS. 2 and 3, a measurement device 200 for measuring the spatial acoustic transfer characteristics Hls, Hlo, Hro, and Hrs will be described. FIG. 2 is a view schematically showing a measurement configuration for carrying out measurement on a person 1 being measured. FIG. 3 is a block diagram showing a configuration of the measurement processor 201 used in the measurement device 200. In this example, the person 1 being measured may be the same as or different from the user U shown in FIG. 1.

As shown in FIG. 2, the measurement device 200 includes a stereo speaker 5 and a microphone unit 2. The stereo speaker 5 is placed in a measurement environment. The measurement environment may be the user U's room at home, a dealer or showroom of an audio system or the like. The measurement environment is preferably a listening room where speakers and acoustics are in good condition.

In this embodiment, the measurement processor 201 of the measurement device 200 performs calculation processing for appropriately generating the spatial acoustic filter. The measurement processor 201 includes, for example, a music player such as a CD player. The measurement processor 201 may be a personal computer (PC), a tablet terminal, a smartphone or the like. Further, the measurement processor 201 may be a server device.

The stereo speaker 5 includes a left speaker 5L and a right speaker 5R. For example, the left speaker 5L and the right speaker 5R are placed in front of the person 1 being measured. The left speaker 5L and the right speaker 5R output impulse sounds for impulse response measurement and the like. Although the number of speakers, which serve as sound sources, is 2 (stereo speakers) in this embodiment, the number of sound sources to be used for measurement is not limited to 2, and it may be any number equal to or larger than 1. Therefore, this embodiment is applicable also to 1ch mono or 5.1ch, 7.1ch etc. multichannel environment.

The microphone unit 2 is stereo microphones including a left microphone 2L and a right microphone 2R. The left microphone 2L is placed on a left ear 9L of the person 1 being measured, and the right microphone 2R is placed on a right ear 9R of the person 1 being measured. To be specific, the microphones 2L and 2R are preferably placed at positions between the entrance of the ear canal and the eardrum of the left ear 9L and the right ear 9R, respectively. The microphones 2L and 2R pick up measurement signals output from the stereo speaker 5 and acquire sound pickup signals. The microphones 2L and 2R output the sound pickup signals to the measurement processor 201. The person 1 being measured may be a person or a dummy head. In other words, in this embodiment, the person 1 being measured is a concept that includes not only a person but also a dummy head.

As shown in FIG. 3, the measurement processor 201 includes a measurement signal generation unit 231, a sound pickup signal acquisition unit 232, a filter generation unit 233, and a filter storage unit 234.

The measurement signal generation unit 231, which includes a D/A converter, an amplifier, and the like, generates measurement signals for measuring spatial acoustic transfer characteristics. The measurement signals are, for example, impulse signals or Time Stretched Pulse (TSP) signals. In this example, the measurement device 200 performs impulse response measurement by using impulse sounds as the measurement signals.

Each of the left microphone 2L and the right microphone 2R of the microphone unit 2 picks up a measurement signal, and outputs the sound pickup signal to the measurement processor 201. The sound pickup signal acquisition unit 232 acquires the sound pickup signals picked up by the left microphone 2L and the right microphone 2R. Note that the sound pickup signal acquisition unit 232 may include an A/D converter that A/D converts the sound pickup signals from the microphones 2L and 2R. The sound pickup signal acquisition unit 232 may perform synchronous addition of signals obtained as a result of a plurality of times of measurement.

As described above, impulse sounds output from the left and right speakers 5L and 5R are measured using the microphones 2L and 2R, respectively, and thereby impulse response is measured. The measurement processor 201 stores the sound pickup signals acquired by the impulse response measurement into a memory or the like. The spatial acoustic transfer characteristics Hls between the left speaker 5L and the left microphone 2L, the spatial acoustic transfer characteristics Hlo between the left speaker 5L and the right microphone 2R, the spatial acoustic transfer characteristics Hro between the right speaker 5R and the left microphone 2L, and the spatial acoustic transfer characteristics Hrs between the right speaker 5R and the right microphone 2R are thereby measured. Specifically, the left microphone 2L picks up the measurement signal that is output from the left speaker 5L, and thereby the spatial acoustic transfer characteristics Hls are acquired. The right microphone 2R picks up the measurement signal that is output from the left speaker 5L, and thereby the spatial acoustic transfer characteristics Hlo are acquired. The left microphone 2L picks up the measurement signal that is output from the right speaker 5R, and thereby the spatial acoustic transfer characteristics Hro are acquired. The right microphone 2R picks up the measurement signal that is output from the right speaker 5R, and thereby the spatial acoustic transfer characteristics Hrs are acquired.

The filter generation unit 233 generates spatial acoustic filters based on the sound pickup signals. The filter generation unit 233 generates the spatial acoustic filters in accordance with the spatial acoustic transfer characteristics Hls, Hlo, Hro, and Hrs from the left and right speakers 5L and 5R to the left and right microphones 2L and 2R. For example, the filter generation unit 233 cuts out the spatial acoustic transfer characteristics Hls, Hlo, Hro, and Hrs with a predetermined filter length. The measurement processor 201 may correct the measured spatial acoustic transfer characteristics Hls, Hlo, Hro, and Hrs.

In this manner, the measurement processor 201 generates the spatial acoustic filter to be used for convolution calculation of the out-of-head localization device 100. As shown in FIG. 1, the out-of-head localization device 100 performs out-of-head localization processing by using the spatial acoustic filters in accordance with the spatial acoustic transfer characteristics Hls, Hlo, Hro, and Hrs between the left and right speakers 5L and 5R and the left and right microphones 2L and 2R. Specifically, the out-of-head localization processing is performed by convolving the spatial acoustic filters into the audio reproduced signals.

The measurement processor 201 performs the same processing on the sound pickup signals that correspond to the respective spatial acoustic transfer characteristics Hls, Hlo, Hro, and Hrs. Specifically, the same processing is performed on each of the four sound pickup signals that correspond to the spatial acoustic transfer characteristics Hls, Hlo, Hro, and Hrs. The spatial acoustic filters that respectively correspond to the spatial acoustic transfer characteristics Hls, Hlo, Hro, and Hrs are thereby generated.

Further, the measurement processor 201 generates a plurality of filters by performing a plurality of times of impulse response measurement. Specifically, the measurement device 200 performs impulse response measurement that uses the left speaker 5L and the left microphone 2L n (n is an integer equal to or greater than two) times, thereby generating n filters corresponding to the spatial acoustic transfer characteristics Hls. By performing impulse response measurement that uses the left speaker 5L and the right microphone 2R n times, n filters corresponding to the spatial acoustic transfer characteristics Hlo are generated.

By performing the impulse response measurement that uses the right speaker 5R and the left microphone 2L n times, n filters corresponding to the spatial acoustic transfer characteristics Hro are generated. By performing impulse response measurement that uses the right speaker 5R and the right microphone 2R n times, n filters corresponding to the spatial acoustic transfer characteristics Hrs are generated.

Here, the spatial acoustic transfer characteristics slightly vary in accordance with the measurement. The results of measuring the spatial acoustic transfer characteristics fluctuate depending on, for example, noise, the face orientation of the person being measured, the wearing state of the microphone, and so on. Therefore, the coefficient of the filter to be generated varies each time the measurement is performed. That is, impulse response measurement is performed on one person being measured n times, whereby n different spatial acoustic filters are generated for each of the spatial acoustic transfer characteristics. Accordingly, it is possible to reproduce fluctuations caused by a human body or the like and improve the localization effect.

The filter storage unit 234 includes a memory or the like that stores filter coefficients. The filter storage unit 234 stores a plurality of filters for each of the spatial acoustic transfer characteristics. For example, the filter storage unit 234 stores n filters for the spatial acoustic transfer characteristics Hls. The filter storage unit 234 stores n filters for the spatial acoustic transfer characteristics Hro. The filter storage unit 234 stores n filters for the spatial acoustic transfer characteristics Hlo. The filter storage unit 234 stores n filters for the spatial acoustic transfer characteristics Hrs. The filter storage unit 234 stores 4n filters.

Here, n filters for one characteristic are also referred to as a filter set or a filter group. That is, the filter set includes n filters. Therefore, the filter storage unit 234 stores four filter sets.

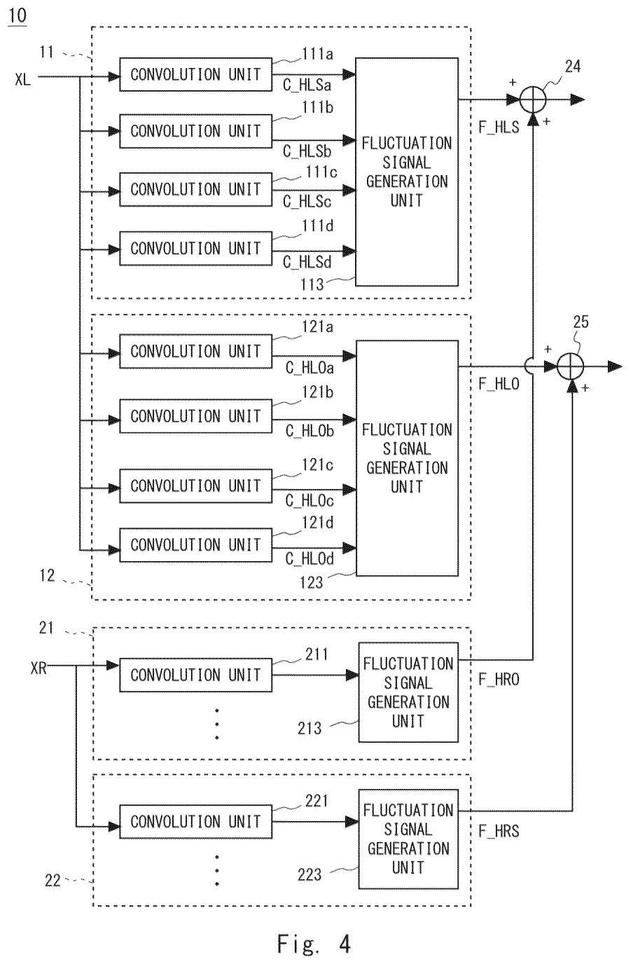

Next, with reference to FIG. 4, spatial acoustic processing that uses a plurality of filters will be described. FIG. 4 is a block diagram showing a configuration of a main part of the spatial acoustic processing unit 10. In this example, the processing on the input signal XL is similar to the processing on the input signal XR. Therefore, processing on the input signal XL will be mainly described, and description regarding the processing on the input signal XR will be omitted as appropriate.

As described above, a plurality of filters are set in the convolution calculation unit 11. While an example in which one filter set includes four filters, i.e., n=4, will be described in this example, the number of filters included in the filter set is not particularly limited.

First, the convolution calculation unit 11 for the spatial acoustic transfer characteristics Hls will be described. The convolution calculation unit 11 includes four convolution units 111a-111d and a fluctuation signal generation unit 113. Filters different from one another are set in the four convolution units 111a-111d. That is, the measurement device 200 measures the spatial acoustic transfer characteristics Hls four times, thereby generating four filters.

The convolution units 111a-111d convolve filters in parallel into the input signal XL. That is, four filters are concurrently convolved into the input signal XL. The signals into which the filters have been convolved by the convolution units 111a-111d are respectively denoted by convolution signals C_HLSa-C_HLSd. The processing by the four convolution units 111a-111d is performed in parallel to each other.

The convolution unit 111a outputs the convolution signal C_HLSa to the fluctuation signal generation unit 113. The convolution unit 111b outputs the convolution signal C_HLSb to the fluctuation signal generation unit 113. The convolution unit 111c outputs the convolution signal C_HLSc to the fluctuation signal generation unit 113. The convolution unit 111d outputs the convolution signal C_HLSd to the fluctuation signal generation unit 113. The four convolution signals C_HLSa-C_HLSd are input to the fluctuation signal generation unit 113.

As described above, the filters set in the convolution units 111a-111d, which exhibit the spatial acoustic transfer characteristics Hls, are generated based on different times of measurement. Therefore, the filter coefficients in the filters set in the convolution units 111a-111d are different from one another. Therefore, the convolution signals output from the convolution units 111a-111d become different from one another.

The fluctuation signal generation unit 113 performs non-linear processing on the four convolution signals C_HLSa-C_HLSd, thereby generating a fluctuation signal F_HLS. For example, the fluctuation signal generation unit 113 generates the fluctuation signal F_HLS by randomly switching the plurality of convolution signals. For example, the fluctuation signal generation unit 113 selects one of the four convolution signals C_HLSa-C_HLSd by using random numbers. The fluctuation signal generation unit 113 generates the fluctuation signal F_HLS by selecting the convolution signal for each sample. By using random numbers whose values change randomly, the fluctuation signal generation unit 113 can generate a fluctuation signal including non-linear fluctuations.

Further, the fluctuation signal generation unit 113 may generate the fluctuation signal F_HLS by switching the plurality of convolution signals C_HLSa-C_HLSd in a unique or desired order. The fluctuation signal generation unit 113 switches, for example, the four convolution signals at constant intervals of the number of samples. In this case, the fluctuation signal generation unit 113 may switch the convolution signal C_HLSa, the convolution signal C_HLSb, the convolution signal C_HLSc, and the convolution signal C_HLSd in this order, or may switch these signals in a desired order. Further, when the fluctuation signal generation unit 113 switches these signals at predetermined intervals of the number of samples, the convolution signals may be synthesized in such a way that they are crossfaded at the switching timing. The intervals of the number of samples for switching the sample may be fixed or may be randomly changed.

Further, the fluctuation signal generation unit 113 may multiply the convolution signals by output coefficients to calculate a sum of convolutional signals. For example, the output coefficients for the four convolution signals C_HLSa-C_HLSd are respectively denoted by coefficients ka-kd. In this case, the fluctuation signal is as shown in the following (1).

F_HLS=ka*C_HLSa+kb*C_HLSb+kc*C_HLSc+kd*HLSc (1)

The sum of four coefficients ka-kd is set to be 1. The fluctuation signal generation unit 113 randomly changes the coefficients ka-kd for each sample. Alternatively, the fluctuation signal generation unit 113 may randomly change the coefficients ka-kd at constant intervals of the number of samples.

The fluctuation signal generation unit 113 outputs the fluctuation signal F_HLS to the adder 24. The fluctuation signal generation unit 113 randomly switches or synthesizes a plurality of convolution signals. It is therefore possible to simulate a part of the non-linearity that may occur when the user listens to a sound from a real sound source in a real space. The calculation method in the fluctuation signal generation unit 113 is not limited to the above-described one.

Next, the convolution calculation unit 12 will be described. The convolution calculation unit 12 performs processing on the spatial acoustic transfer characteristics Hlo that is similar to the processing that the convolution calculation unit 11 performs. Therefore, the convolution calculation unit 12 includes four convolution units 121a-121d and a fluctuation signal generation unit 123. Filters different from one another are set in the four convolution units 121a-121d. That is, the measurement device 200 measures the spatial acoustic transfer characteristics Hlo four times, thereby generating four filters.

The convolution units 121a-121d convolve filters in parallel into the input signal XL. That is, four filters are concurrently convolved into the input signal XL. The signals into which the filters have been convolved by the convolution units 121a-121d are referred to as convolution signals C_HLOa-C_HLOd, respectively. The processing performed by the four convolution units 121a-121d is performed in parallel to each other.

The fluctuation signal generation unit 123 generates a fluctuation signal F_HLO by performing non-linear processing on the four convolution signals C_HLOa-C_HLOd. That is, the fluctuation signal generation unit 123 generates the fluctuation signal F_HLO by a method the same as that in the fluctuation signal generation unit 113. For example, the fluctuation signal generation unit 113 randomly switches or synthesizes a plurality of convolution signals. The fluctuation signal generation unit 123 outputs the fluctuation signal F_HLO to the adder 25.

The convolution calculation units 21 and 22 perform similar processing on the input signal XR. For example, the convolution calculation unit 21 includes a plurality of convolution units 211 and a fluctuation signal generation unit 213. The plurality of convolution units 221 convolve filters different from one another into the input signal XR. The fluctuation signal generation unit 213 generates a fluctuation signal F_HRO by performing non-linear processing. The fluctuation signal generation unit 213 switches or synthesizes a plurality of convolution signals, thereby outputting the fluctuation signal F_HRO to the adder 24. The adder 24 outputs an addition signal obtained by adding the fluctuation signal F_HLS and the fluctuation signal F_HRO to the inverse filter unit 41 shown in FIG. 1.

The convolution calculation unit 22 includes a plurality of convolution units 221 and a fluctuation signal generation unit 223. The plurality of convolution units 221 convolve filters different from each other into the input signal XR. The fluctuation signal generation unit 223 generates a fluctuation signal F_HRS by performing non-linear processing. The fluctuation signal generation unit 223 generates the fluctuation signal F_HRS by switching or synthesizing a plurality of convolution signals. The convolution calculation unit 22 outputs the fluctuation signal F_HRS to the adder 25. The adder 25 outputs an addition signal obtained by adding the fluctuation signal F_HLO and the fluctuation signal F_HRS to the inverse filter unit 42 shown in FIG. 1.

As described above, in each channel, the spatial acoustic processing unit 10 convolves a plurality of filters concurrently and in parallel to each other. The fluctuation signal generation units 113, 123, 213, and 223 each generate the fluctuation signal by switching or synthesizing the digital signals for each sample. The fluctuation signal generation units 113, 123, 213, and 223 each generate the fluctuation signal by switching or synthesizing the digital signals for each predetermined sample.

It is therefore possible to reproduce spatial fluctuations in a simulated manner. This allows the user U to listen to sounds with a higher sense of realism and obtain the out-of-head localization effect with a high accuracy. By using random numbers or the like, signals and coefficients can be randomly changed. Therefore, reproducibility of spatial fluctuations is enhanced.

### Modified Example

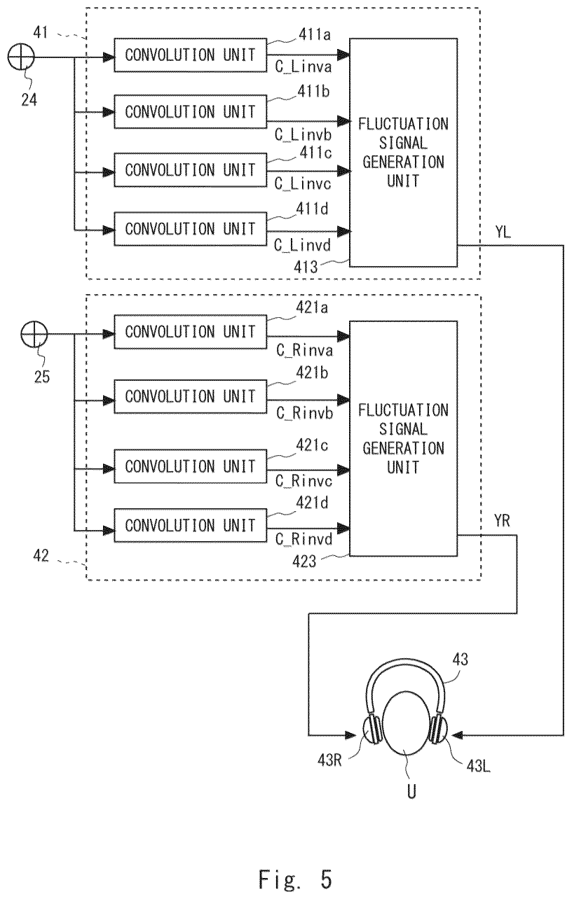

While the spatial acoustic processing unit 10 generates fluctuation signals in the above description, the inverse filter units 41 and 42 may generate fluctuation signals. With reference to FIG. 5, a modified example in which the inverse filter units 41 and 42 generate fluctuation signals will be described. FIG. 5 is a block diagram showing a configuration of the inverse filter units 41 and 42.

The inverse filter unit 41 includes a plurality of convolution units 411a-411d and a fluctuation signal generation unit 413. The inverse filter unit 41 stores a plurality of inverse filters Linv. The convolution units 411a-411d store inverse filters Linv different from one another. Then, the convolution units 411a-411d convolve different inverse filters Linv concurrently and in parallel with each other into an addition signal from the adder 24.

As a result of a plurality of times of measurement of ear canal transfer characteristics, a plurality of inverse filters Linv are generated. While the number of convolution units 411a-411d is four, it may be any number equal to or greater than two. As a matter of course, the number of convolution units 411a to 411d in the inverse filter unit 41 and the number of convolution units 211 and the like may be different from each other or may be the same number.

The signals into which inverse filters Linv have been convolved by the convolution units 411a-411d are respectively denoted by convolution signals C_Linva-C_Linvd. The convolution unit 411a outputs the convolution signal C_Linva to the fluctuation signal generation unit 413. Likewise, the convolution units 411b-411d output the convolution signals C_Linvb-C_Linvd to the fluctuation signal generation unit 413. The fluctuation signal generation unit 413 generates a fluctuation signal from the plurality of convolution signals, just like the fluctuation signal generation unit 113 and so on. The inverse filter unit 41 outputs the fluctuation signal generated by the fluctuation signal generation unit 413 to the left unit 43L as an L-ch signal YL.

Likewise, the inverse filter unit 42 includes a plurality of convolution units 421a-421d and a fluctuation signal generation unit 423. The inverse filter unit 42 stores a plurality of inverse filters Rinv. The convolution units 421a-421d store inverse filters Rinv different from one another. Then, the convolution units 421a-421d convolve different inverse filters Rinv concurrently and in parallel with each other into an addition signal from the adder 25.

A plurality of inverse filters Rinv are generated by performing a plurality of times of measurement of ear canal transfer characteristics. While the number of convolution units 421a-421d is four, it may be any number equal to or greater than two. As a matter of course, the number of convolution units 421a-421d in the inverse filter unit 42, and the number of convolutional units 411a-411d in the inverse filter units 41, convolution units 211 and so on may be different from each other or may be the same.

Signals into which the inverse filters Rinv have been convolved by the convolution units 421a-421d are respectively denoted by convolution signals C_Rinva-C_Rinvd. The convolution unit 421a outputs the convolution signal C_Rinva to the fluctuation signal generation unit 423. Likewise, the convolution units 421b-421d respectively output the convolution signals C_Rinvb-C_Rinvd to the fluctuation signal generation unit 423. The fluctuation signal generation unit 423 generates a fluctuation signal from the plurality of convolution signals, just like the fluctuation signal generation units 113, 413, and so on. The inverse filter unit 42 outputs the fluctuation signal generated by the fluctuation signal generation unit 423 to the right unit 43R as an output signal YR. Then, output signals YL and YR on which out-of-head localization processing has been performed are reproduced from the headphones 43.

As described above, the inverse filter units 41 and 42 may generate fluctuation signals. The inverse filter units 41 and 42 generate the fluctuation signals by switching or synthesizing the digital signal for each sample. It is therefore possible to reproduce spatial fluctuations in a simulated manner. This allows the user U to listen to sounds with a higher sense of realism and obtain the out-of-head localization effect with a high accuracy. Since signals and coefficients can be randomly changed by using random numbers, the level of reproducibility of spatial fluctuations increases.

### (Spatial Acoustic Processing Method)

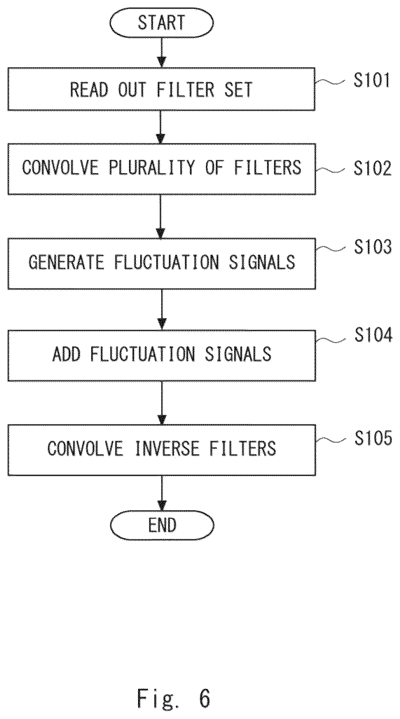

With reference to FIG. 6, a spatial acoustic processing method will be described. FIG. 6 is a flowchart showing the spatial acoustic processing method. First, the spatial acoustic processing unit 10 reads out a filter set stored in the filter storage unit 234 (S101). As described above, the filter set includes a plurality of filters for one spatial acoustic transfer characteristic. In this example, the spatial acoustic processing unit 10 reads out the filter sets corresponding to the spatial acoustic transfer characteristics Hls, Hlo, Hro, and Hrs. That is, the spatial acoustic processing unit 10 reads out four filter sets.

Next, a convolution unit convolves a plurality of filter sets in parallel into each of the input signals XL and XR (S102). Specifically, the convolution units 111a-111d shown in FIG. 4 convolve filters into the input signal XL. The convolution units 121a-121d convolve filters into the input signal XL. The convolution unit 211 convolves a plurality of filters into the input signal XR. The convolution unit 221 convolves a plurality of filters into the input signal XR.

Then, the fluctuation signal generation units 113, 123, 213, and 223 generate fluctuation signals based on a plurality of convolution signals (S103). For example, the fluctuation signal generation unit 113 generates a fluctuation signal F_HLS by performing non-linear processing such as switching, synthesis or the like of the plurality of convolution signals. The fluctuation signal generation unit 123 generates a fluctuation signal F_HLO by performing non-linear processing such as switching and synthesis of a plurality of convolution signals. The fluctuation signal generation unit 213 generates a fluctuation signal F_HRO by performing non-linear processing such as switching and synthesis of a plurality of convolution signals. The fluctuation signal generation unit 223 generates a fluctuation signal F_HRS by performing non-linear processing such as switching and synthesis of a plurality of convolution signals.

Then, the adders 24 and 25 add the fluctuation signals (S104). The adder 24 adds the fluctuation signal F_HLS and the fluctuation signal F_HRO, and outputs the addition signal to the inverse filter unit 41. The adder 25 adds the fluctuation signal F_HLO and the fluctuation signal F_HRS, and outputs the addition signal to the inverse filter unit 42.

The inverse filter units 41 and 42 respectively convolve the inverse filters Linv and Rinv into the addition signals (S105). Accordingly, reproduced signals on which out-of-head localization processing has been performed are reproduced from the headphones 43. As a matter of course, in S105 as well, as shown in FIG. 5, the inverse filter units 41 and 42 may use fluctuation signals.

While the measurement device 200 generates a filter set by a plurality of times of measurement on the person 1 being measured in the above embodiment, the filter set may be generated by another method. The filter set may be generated by, for example, measurement on a person being measured other than the user. In this case, the out-of-head localization device 100 may specify a person being measured having characteristics similar to the characteristics of the user by predetermined matching processing. Then the out-of-head localization device 100 uses filters of a person being measured whose characteristics are similar to those of the user.

Regarding the spatial acoustic transfer characteristics, a filter set may be generated for each speaker. Regarding the ear canal transfer characteristics, a filter set may be generated for each pair of headphones or for each pair of earphones. Then the user selects the device to be used from among preset filter sets. It is therefore possible to acquire an appropriate filter set. The user may download a filter set via a network such as the internet. This allows the user to perform out-of-head localization listening in a desired environment.

While input signals are assumed to be 2-ch stereo input signals in the above description, the input signals may instead be 5.1-ch or 7.1-ch multichannel signals. In this case, for each speaker of each channel, a plurality of filters may be set for each speaker of each channel. That is, a filter set including a plurality of filters is set for the spatial acoustic transfer characteristics from the speaker of each channel to the left ear. A filter set including a plurality of filters is set for the spatial acoustic transfer characteristics from the speaker of each channel to the right ear. The adders 24 and 25 may add three or more fluctuation signals.

A part or the whole of the above-described processing may be executed by a computer program. The above-described program can be stored and provided to the computer using any type of non-transitory computer readable medium. The non-transitory computer readable medium includes any type of tangible storage medium. Examples of the non-transitory computer readable medium include magnetic storage media (such as flexible disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Although embodiments of the invention made by the present inventors are specifically described in the foregoing, the present invention is not restricted to the above-described embodiments, and various changes and modifications may be made without departing from the scope of the invention.

The present disclosure is applicable to a spatial acoustic processing device and a spatial acoustic processing method.

What is claimed is:

1. A spatial acoustic processing device comprising:
a filter storage unit configured to store a filter set having a plurality of first filters which are based on one spatial acoustic transfer characteristic;
a first convolution unit configured to generate a plurality of first convolution signals by convolving the plurality of first filters in parallel into a first input signal of a first channel;
a first fluctuation signal generation unit configured to generate a first fluctuation signal by performing non-linear processing on the plurality of first convolution signals; and
a filter processing unit configured to generate an output signal by convolving a second filter into the first fluctuation signal.

2. The spatial acoustic processing device according to claim 1, wherein
the filter processing unit comprises:
a second convolution unit configured to generate a plurality of second convolution signals by convolving a plurality of second filters in parallel into the first fluctuation signal; and
a second fluctuation signal generation unit configured to generate a second fluctuation signal by performing non-linear processing on the plurality of second convolution signals.

3. The spatial acoustic processing device according to claim 2, comprising:
a third convolution unit configured to generate a plurality of third convolution signals by convolving a plurality of third filters in parallel into a second input signal of a second channel;
a third fluctuation signal generation unit configured to generate a third fluctuation signal by performing non-linear processing on the plurality of third convolution signals; and
an adder configured to output an addition signal obtained by adding the first fluctuation signal and the third fluctuation signal to the filter processing unit.

4. The spatial acoustic processing device according to claim 3, wherein the first fluctuation signal generation unit generates a first fluctuation signal by selecting one of the plurality of first convolution signals.

5. The spatial acoustic processing device according to claim 3, wherein the first fluctuation signal generation unit generates a first fluctuation signal by multiplying the plurality of first convolution signals by each output coefficient and calculating a sum of the plurality of first convolutional signals multiplied by the output coefficient.

6. The spatial acoustic processing device according to claim 1, further comprising:
a measurement processing unit configured to measure the spatial acoustic transfer characteristics of a person being measured a plurality of times,
wherein the first filter corresponding to each of the spatial acoustic transfer characteristics measured the plurality of times is generated in order to generate the plurality of first filters.

7. A spatial acoustic processing method comprising:
a step of reading out a filter set having a plurality of first filters which are based on one spatial acoustic transfer characteristic from a filter storage unit;
a first convolution step configured to generate a plurality of first convolution signals by convolving the plurality of first filters in parallel into a first input signal of a first channel;
a first fluctuation signal step of generating a first fluctuation signal by performing non-linear processing on the plurality of first convolution signals; and
a filter processing step of generating an output signal by convolving a second filter into the first fluctuation signal.
